(19) United States
(12) Patent Application Publication
(10) Pub. No.: US 2010/0257170 A1
(43) Pub. Date: Oct. 7, 2010

(54) NAMING SERVICE SYSTEM AND METHOD OF SCA-BASED APPLICATION COMPONENT

(75) Inventors: Hongsoog Kim, Daejeon (KR); Namhoon Park, Daejon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecomunications Research Institute, Daejeon-city (KR)

(21) Appl. No.: 12/742,789

(22) PCT Filed: Sep. 3, 2008
(86) PCT No.: PCT/KR08/05169

§ 371 Date: May 13, 2010

(30) Foreign Application Priority Data
Dec. 17, 2007 (KR) 10-2007-0132743

(51) Int. Cl. G06F 15/16; G06F 17/30

(52) U.S. Cl. 707/737; 709/203; 707/769; 707/E17.014; 707/E17.089

(57) ABSTRACT

Disclosed is a naming service system and method of an SCA-based application component. The naming service system includes a naming service server having an arrangement information analyzing module, a database module, and a naming service deploying module, and a plurality of clients each having a module for selecting a naming service server for registration and a module for selecting an optimum naming service server for search. The naming service method includes: obtaining arrangement information of components forming an SCA-based application from hostcollocation elements of an SAD file; deploying local naming services for each node; arranging the naming services according to information of a naming service allocation table; and providing a function of registering a naming service of the component. When searching the IOR of a component, the naming service server selects an optimum naming service from a local naming service and a remote naming service, thereby providing a high-speed naming service.

### TECHNICAL FIELD

The present invention relates to a naming service system and method, and more particularly, to a naming service system and method of an SCA-based application component.

This work was supported by the IT R&D program of MIC/IITA [2006-S-012-02, Development of Middleware Platform Technology Based on the SDR Mobile Station].

### BACKGROUND ART

In a JTRS(joint tactical radio system) SCA (software communications architecture)-based system, an application is composed of two or more components. The SCA is a software framework that is designed on the basis of an SDR (software defined radio, which is software-based wireless communication) software reference model.

The components forming the application register their IORs (interoperable object references) in a CORBA (common object request broker architecture)-based naming service, and use the naming service to search the IOR of another component forming the application or a system component. The naming service is frequently used to register the IOR of each component when an application starts, or to perform communication between the components while the application is operated.

Therefore, in the SCA-based system, the components forming the application may be distributed to two or more nodes. In this case, a naming service speed depends on whether the remote naming service or the local naming service is used. In the SCA-based system, the arrangement of the components forming the application for each node depends on a software assembly descriptor (hereinafter, referred to as an SAD) file of the application. The SAD file describes instructions for the arrangement of the components on the nodes in a hostcollocation element. Each node corresponds to one hostcollocation element, and the components arranged in the node are described in component placement sub-elements of the hostcollocation element.

In the SCA-based system, the application uses the arrangement information of the components in the SAD file to perform a local naming service for each node corresponding to the hostcollocation element, and the components designated in the componentplacement sub-elements of the same hostcollocation element use the local naming service to search the IORs of components in the same hostcollocation element. When searching the other components, the remote naming service that is performed on the node where a component to be searched is arranged is searched. In this way, it is possible to improve an application search speed.

Further, when an application component developer has information on the operational characteristics of components and the component that is frequently searched is registered in the local naming service, in which a component performing a search is registered, in the SCA-based system, the application can search the IOR of the component using the local naming service, instead of the remote naming service.

FIG. 1 is a diagram illustrating the structure of a naming service system in a distributed processing system according to the related art.

The distributed processing system using CORBA implements a client 11 and a server 12 according to an interface defined by an IDL (interface definition language). The server registers an object reference in a naming server 10, and the client acquires the reference of an implementation object of the server and calls an object method of a remote server. In this way, communication is performed between the client 11 and the server 12.

The client 11 uses a registered name that is allowed to access an object including a method that the client wants to call to acquire the reference of the implementation object of a CORBA server, which is called a naming service.

When the naming service is used to perform ORB communication for different types of platforms of ORB (object request broker) vendors, the client 11 receives an IOR (interoperable object reference) file of an object of the remote server 12 to acquire the reference of the server object, in order to ensure compatibility. In this way, communication is performed between the client 11 and the server 12.

Since the configuration of the naming service follows an SCA standard, the configuration of the naming service is not particularly defined. However, a high-speed naming service is needed to perform the actual operation. In particular, in the SCA-based system, the application greatly depends on the naming service, in order to register the components when the application starts and to search another service component. Therefore, a high-speed naming service is needed to rapidly start the application.

### DISCLOSURE OF INVENTION

### Technical Problem

An object of the invention is to provide a method of obtaining arrangement information of components forming an application from hostcollocation elements of an SAD file, and deploying local naming services for each node in an SCA-based system.

Another object of the invention is to provide a method of, when the search of IORs of components to be loaded or executed at a node is requested, selecting an optimum naming service from a local naming service and a remote naming service to provide a high-speed naming service.

### Technical Solution

According to an aspect of the invention, there is provided a naming service system for an SCA (software communications architecture)-based application component. The system includes: an arrangement information analyzing module that analyzes the arrangement information of the components forming an application from a software assembly descriptor file; a naming service deploying module that receives the arrangement information of the components and provides the deployment result of naming services on the basis of the received information; and a database module that stores the arrangement information of the components and the deployment result of the naming services, and transmits the arrangement information of the components and the deployment result of the naming services to a client at the request of the client.

The database module may receive, from the client, a request for a naming service server for registering IDs of the components forming the application, analyze the arrangement information of the components and the deployment result of the naming services, and transmit the information on the naming service server for registration to the client.

The database module may receive, from the client, a request for a naming service server most suitable for an ID of a component to be searched, analyze the arrangement information of the components and the deployment result of the naming services, and transmit, to the client, information on the naming service server most suitable for the component to be searched.

The client may include: a module for selecting a naming service server for registration that, when the component starts its operation, automatically selects a naming service server for registering an ID of the component; and a module for selecting an optimum naming service server for search, which analyzes a naming service request in the component and selects an optimum naming service, when wanting to search the component in order for interaction between the component and another component, during the operation of the component.

The client may use a CORBA naming service to search the SCA-based application component.

According to another aspect of the invention, there is provided a naming service method of an application component in an SCA-based system. The method includes: (a) a step of allowing an arrangement information analyzing module to obtain the arrangement information of the components forming an application from a software assembly descriptor according to a naming service allocation table, and to store the information in a database module; (b) a step of allowing a naming service deploying module to deploy local naming service servers according to nodes, on the basis of the arrangement information of the components; and (c) a step of allowing the database module to receive a request for a naming service server for registering IDs of the components forming the application from a module for selecting a naming service server for registration in a client, to analyze information on the deployment of naming service servers, and to transmit information on a naming service server for registration to the module for selecting a naming service server for registration.

The naming service method may further include (d) a step of allowing the database module to, during the operation of the component of the client, receive a request for a naming service server most suitable for an ID of a component to be searched, from a module for selecting an optimum naming service server for search of the client, to analyze the information on the deployment of the naming service servers, and to transmit information on the naming service server most suitable for the component to be searched to the module for selecting an optimum naming service server for search.

The naming service method may further include (A) before the step (a), a step of arranging the naming services according to information of the naming service allocation table.

The step (A) may include: (A1) a sub-step of allowing the arrangement information analyzing module to, when there is partitioning information in a SAD file, allocate a new local naming service name to a node corresponding to a portion that designates the components arranged for each node, and to record the newly allocated local naming service name on the naming service allocation table; and (A2) a sub-step of allowing the arrangement information analyzing module to designate the naming service currently allocated to the node as a local naming service, for the component specified in componentplacement that will be executed in the node.

The step (b) may include: (b1) a sub-step of allowing the naming service deploying module to, when the component uses the naming service, search the naming service allocated thereto from the naming service allocation table; (b2) a sub-step of allowing the naming service deploying module to determine whether the naming services are allocated thereto from the naming service allocation table, and to register its own IOR (interoperable object reference) in the allocated naming service(s); and (b3) a sub-step of allowing the naming service deploying module to provide error processing information when the component uses the naming service, but is not allocated with the naming service.

The step (b) may further include: (b4) a sub-step of allowing the naming service deploying module to receive the arrangement information of the components from the database module, to deploy necessary naming service servers in the nodes according to information of the naming service allocation table, and to transmit the deployment result of the naming services to the database module.

According to still another aspect of the invention, there is provided a naming service method of an SCA-based application component. The method includes: (a) when a component to be searched uses a naming service, a step of searching the naming services registered in a naming service allocation table; (b) when one or more naming services are searched, a step of determining whether a local naming service in which the component to be searched is registered is included in the search result of the naming service; (c) when there is no naming service search result, a step of performing error processing; and (d) when the local naming service in which the component to be searched is registered is included in the search result of the naming service, a step of using the local naming service to request the search of an IOR of the component to be searched.

The naming service method may further include (e) when the local naming service in which the component to be searched is registered is not included in the search result of the naming service, a step of allowing a component that performs a search to use a remote naming service to request the search of the IOR of the component to be searched.

The naming service method may further include: when the component to be searched is registered in both the local naming service and the remote naming service, a step of allowing the component that performes a search to use the local naming service to request a search.

### Advantageous Effects

According to the invention, a process of registering a component using a naming service in the naming service and a process of requesting a search are optimized in respects to spatial locality, which makes it possible to provide a high-speed naming service. In addition, a developer can search information of a desired component, on the basis of information on the internal operation of an application component, by registering the component in a local naming service.

### BRIEF DESCRIPTION OF THE DRAWINGS

FIG. 1 is a diagram illustrating the structure of a naming service system in a distributed processing system according to the related art.

FIG. 2 is a diagram illustrating an SAD file of an SCA application according to an embodiment of the invention.

FIG. 3 is a diagram illustrating the arrangement of components for the SAD file shown in FIG. 2.

FIG. 4 is a naming service allocation table of application components that is made according to arrangement information of the application components shown in FIG. 2.

FIG. 5 is a diagram illustrating the arrangement of naming services and components when a single naming service is provided.

FIG. 6 is a diagram illustrating the arrangement of the naming services deployed on the nodes according to the naming service allocation table shown in FIG. 4, in consideration of spatial locality.

FIG. 7 is a flowchart illustrating a process of performing a naming service according to the naming service allocation table based on spatial locality from the SAD file according to the invention.

FIG. 8 is a flowchart illustrating a process of, when a component using the naming service starts, registering the component in the naming service allocated for each component according to the naming service allocation table according to an embodiment of the invention.

FIG. 9 is a flowchart illustrating a process of selecting a naming service to use when a component using the naming service described in an SAD file searches an IOR (interoperable object reference) of another component from the naming service allocation table.

FIG. 10 is a diagram illustrating the structure of a system for operating a naming service of an SCA-based application component according to the invention.

FIG. 11 is a flowchart illustrating a naming service of an SCA-based application component.

### REFERENCE NUMERALS

900: naming service server
901: arrangement information analyzing module
902: database module
903: naming service deploying module
910: client
911: module for selecting naming service server for registration
912: module for selecting naming service server for search
C_00, C_01, C_02, C_03, C_04, C_05: component name
DEV_00, DEV_01, DEV_02: name of allocated device
NS_00, NS_01, NS_02: name of NS to be registered

### BEST MODE FOR CARRYING OUT THE INVENTION

Hereinafter, exemplary embodiments of the invention will be described in detail with reference to the accompanying drawings.

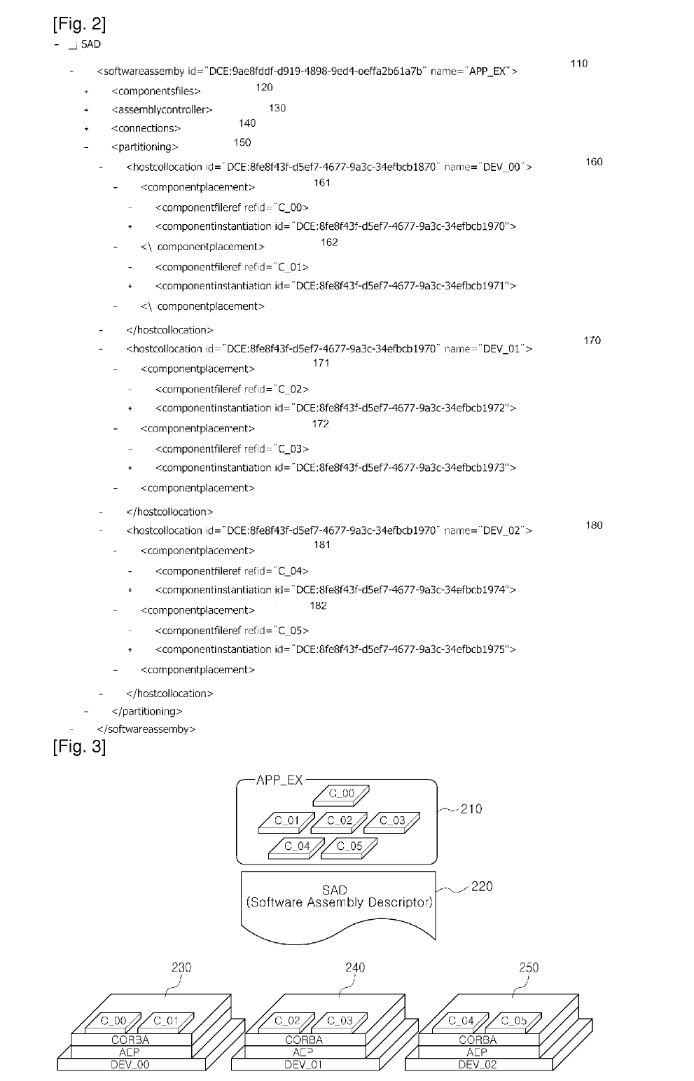

FIG. 2 is a diagram illustrating an SAD file of an SCA application according to an embodiment of the invention.

The SAD (software assembly descriptor) file includes a portion 110 that designates the name and ID of one application, a portion 120 in which components forming the application are arranged, a portion 130 that designates a representative component of an application instance, a portion 140 that describes connection information between the components of the application, and a portion 150 that describes the arrangement information of the application components.

The portion 150 that describes the arrangement information of the application components includes parts 160, 170, and 180 that designate components to be arranged for each node.

The components of the SCA application are arranged at designated nodes according to the portion 150 that describes the arrangement information of the application components.

The invention provides a method of configuring a naming service in consideration of spatial locality of application components in a system following a JTRS(joint tactical radio system) SCA (software communications architecture) standard, a method of registering a naming service of components supporting the naming service configuring method, a naming service arrangement method, and a process of selecting an optimum naming service when the search of a component is requested.

The term “application” described in the specification is composed of distributed components following the SCA standard, and uses a CORBA naming service or a service corresponding thereto in order to search the components.

The terms used in the specification are apparently defined as follows.

The term “naming service” means a software program that provides a function of registering information on IORs (interoperable object reference) of components that are executed in a distributed application and a function of searching the registered IOR information of the components.

The term “component performing a search” means a component that uses a naming service to perform a search request, in order to perform its own operation and to search the IOR of a specific component.

The term “component to be searched” means a component, which is an object whose

IOR will be searched through the naming service.

The term “local naming service” means a naming service that is provided by a node where the component performing a search is being executed.

The term “remote naming service” means a naming service that is provided by remote nodes other than the node where the component performing a search is being executed.

FIG. 3 is a diagram illustrating the arrangement of components for the SAD file shown in FIG. 2.

The application configured by the SAD file shown in FIG. 2 conceptually includes six components (C_00, C_01, C_02, C_03, C_04, and C_05) 210, which are described in the SAD file 220. The components are arranged in the nodes according to the content described in the SAD file.

Referring to reference numeral 160 in FIG. 2, as shown in FIG. 3 as reference numeral 230, the application components C_00 and C_01 are arranged on an allocated device DEV_00.

Referring to reference numeral 170 in FIG. 2, as shown in FIG. 3 as reference numeral 240, the application components C_02 and C_03 are arranged on an allocated device DEV_01.

Referring to reference numeral 180 in FIG. 2, as shown in FIG. 3 as reference numeral 250, the application components C_04 and C_05 are arranged on an allocated device DEV_02.

When the components are arranged as shown in FIG. 3, the components forming the application do not have any information on a naming service that will register the components. As shown in FIG. 5, when a single naming service is provided, all the components except for the components C_00 and C_01 should use a remote naming service NS_00 because there is no naming service in the nodes where they are being executed. In this case, the time required to register the components in the remote naming service is longer than the time required to register the components in the local naming service.

In FIG. 5, all of the components except for the components C_00 and C_01 should request the search of the remote naming service, in order to search the IORs of other components.

For example, in order to search the IOR of the component C_03 that is in the same node, the component C_02 should depend on the remote naming service NS_00. This problem occurs because the spatial locality between the naming service and the component is not being used.

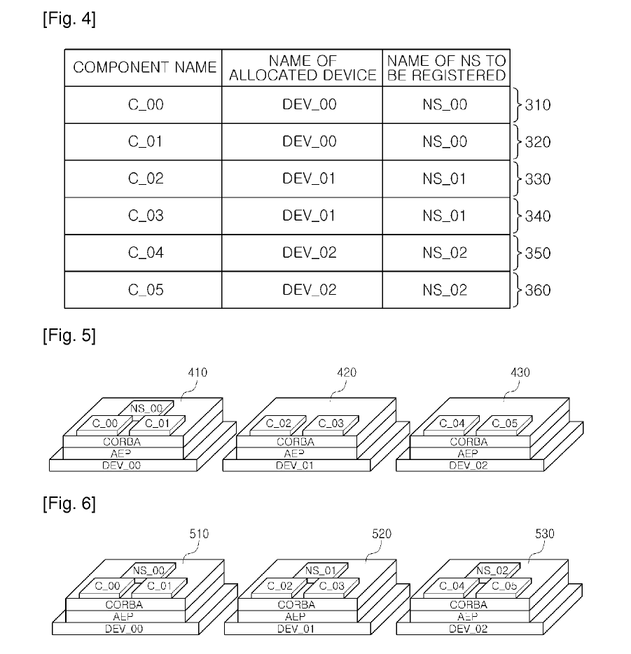

FIG. 4 is a naming service allocation table of the components that is made on the basis of the arrangement information of the application components shown in FIG. 2.

FIG. 4 shows a naming service allocation table used when the portion 150 that describes the arrangement information of the application components, which is shown in FIG. 2, analyzes the spatial locality of the arrangement information to designate a local naming service for each component.

In the naming service allocation table shown in FIG. 4, one naming service is designated to each node, and local naming services NS_00, NS_01, and NS_02 are allocated to components that are executed in the corresponding node.

FIG. 6 is a diagram illustrating the arrangement of the naming services that are deployed in the nodes in consideration of the spatial locality, according to the naming service allocation table shown in FIG. 4.

When the local naming services are deployed in the nodes as shown in FIG. 6, a naming service request between the components in the same node (510, 520, or 530) is executed by the local naming service (NS_00, NS_01, or NS_02).

FIG. 4 shows a naming service allocation table of components according to the analysis of the SAD file, but an application designer may additionally register the components that are frequently referred according to their operational characteristics in the remote naming service having the components that are frequently referred as well as the local naming service.

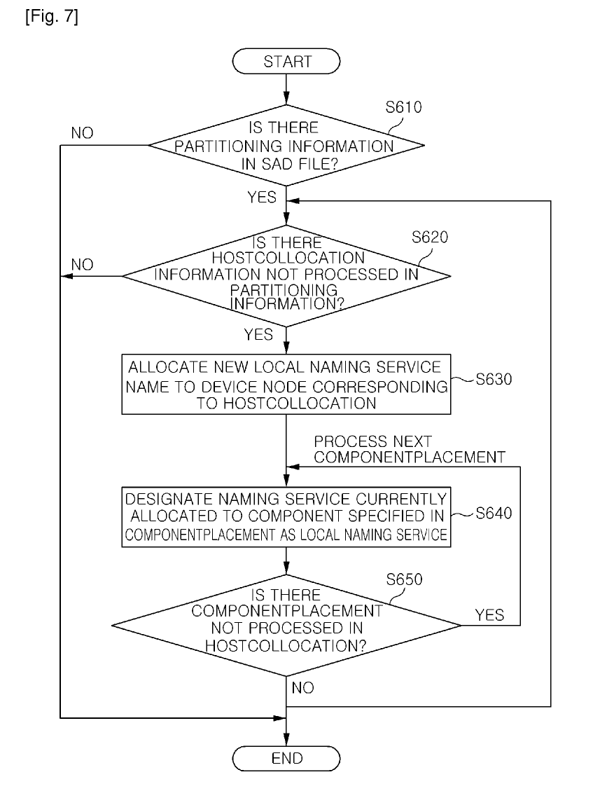

FIG. 7 is a flowchart illustrating a process of performing a naming service according to the naming service allocation table based on the spatial locality from the SAD file according to the invention.

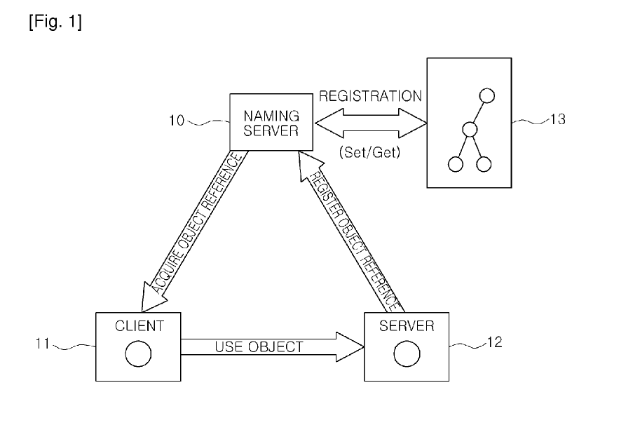

First, an arrangement information analyzing module checks whether there is partitioning information (reference numeral 150 in FIG. 2) in the SAD file (S610). When there is partitioning information in the SAD file, the arrangement information analyzing module processes hostcollocations corresponding to the parts 160, 170, and 180, which designate the components to be arranged for each node, as shown in FIG. 1 (S620). In order to perform this process, the arrangement information analyzing module allocates new local naming services to nodes corresponding to the hostcollocations, and records the names of the allocated local naming services on the naming service allocation table (S630). In this case, the arrangement information analyzing module performs the local naming service allocated to the corresponding node.

The arrangement information analyzing module designates the naming service currently allocated to the node as a local naming service, for the components specified in componentplacement to be executed in the corresponding node (S640).

As shown in reference numerals 160, 161, and 162 in FIG. 2, the arrangement information analyzing module determines whether there is a component to be additionally processed, preparing for when two or more components are arranged in one node (S650). When it is determined that there is a component to be additionally processed, the arrangement information analyzing module processes the next componentplacement.

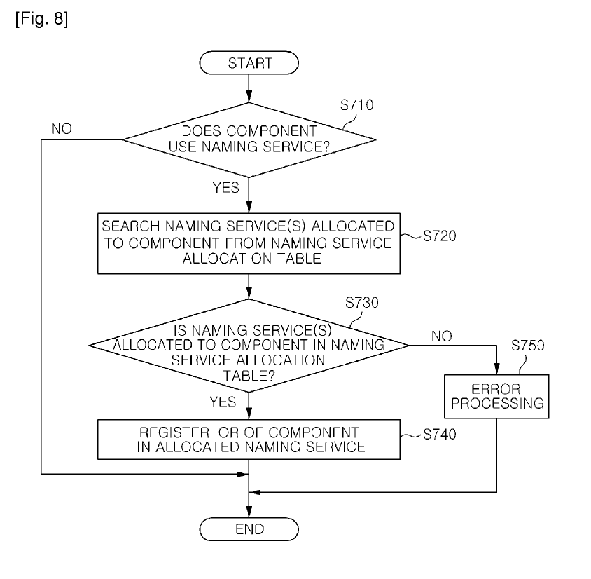

FIG. 8 is a flowchart illustrating a process of registering components in the naming services allocated thereto according to the naming service allocation table according to an embodiment of the invention, when the components using the naming service start.

A naming service deploying module determines whether a component uses the naming service (S710). When it is determined that the component uses the naming service, the naming service deploying module searches the naming service(s) allocated thereto from the naming service allocation table (S720), determines whether its own naming service(s) is allocated to the naming service allocation table (S730), and registers its own IOR (Interoperable Object Reference) in the naming service(s) (S740).

When the component using the naming service is not allocated with the naming service in Step S730, the naming service deploying module provides error processing information to the user (S750).

When the SAD file is correctly created and the naming service allocation table is created, no problem occurs. However, when errors occur, the naming service deploying module notifies the user of the content of error processing.

When the developer determines that it is necessary to additionally allocate one or more naming services to the component in the naming service allocation table, one or more naming services may be allocated to the component.

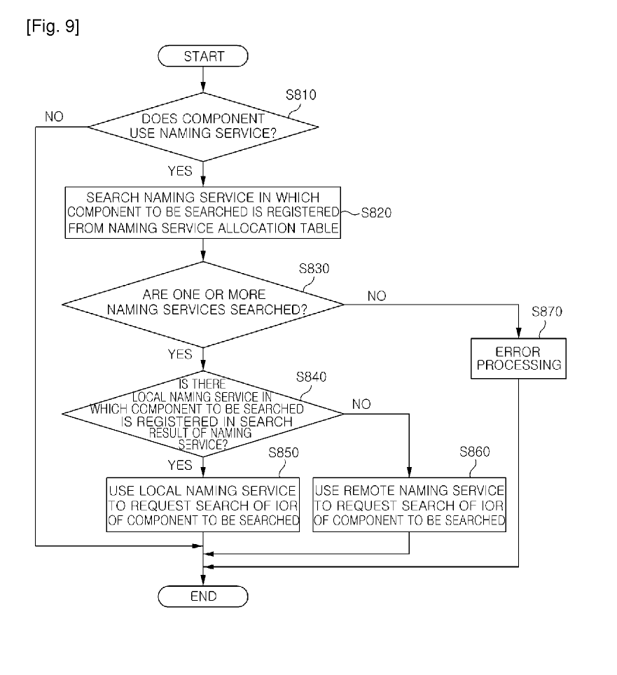

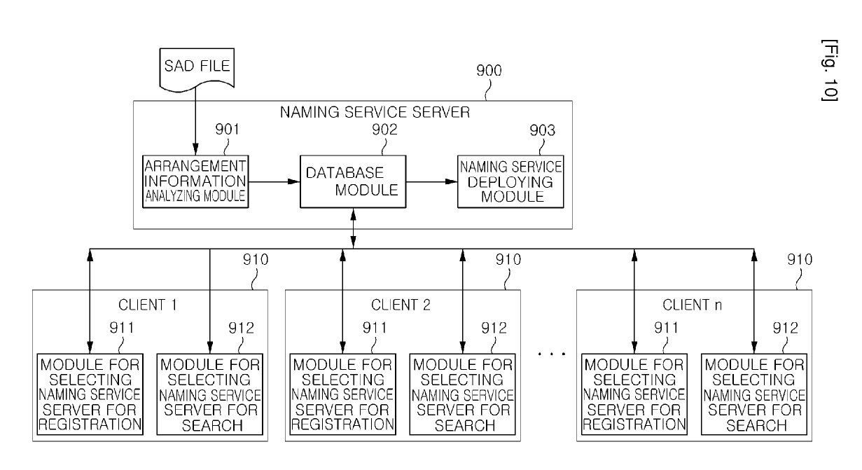

FIG. 9 is a flowchart illustrating a process of selecting a naming service to use while a component that uses the naming service described in the SAD file according to the naming service allocation table searches the IOR (interoperable object reference) of another component using the naming service.

First, a component performing a search (a component that requests a search) determines whether a component to be searched uses the naming service (S810). When it is determined that the component uses the naming service, the naming services are searched from the naming service allocation table (S820).

The component performing a search determines whether one or more naming services are searched (S830). When it is determined that one or more naming services are searched, the component determines whether the local naming service in which the component to be searched is registered is included in the search result of the naming service (S840).

When there is no naming service search result, the component that requests a search performs error processing (S870). When the SAD file is correctly created and the naming service allocation table is created, no error occurs. However, when an error occurs, the component that requests a search notifies the user of the content of error processing.

When it is determined in Step S840 that the local naming service in which the component to be searched is registered is included in the search result of the naming service, the component that performs a search requests the search of the IOR (interoperable object reference) of a component to be searched using the local naming service (S850).

When it is determined in Step S840 that the local naming service in which the component to be searched is registered is not included in the search result of the naming service, the component that performs a search requests the search of the IOR of the component to be searched using the remote naming service (S860).

When it is determined in Steps S840 and S850 that the component to be searched is registered in both the local naming service and the remote naming service, the component that performs a search uses the local naming service to perform a search because it is faster than the remote naming service.

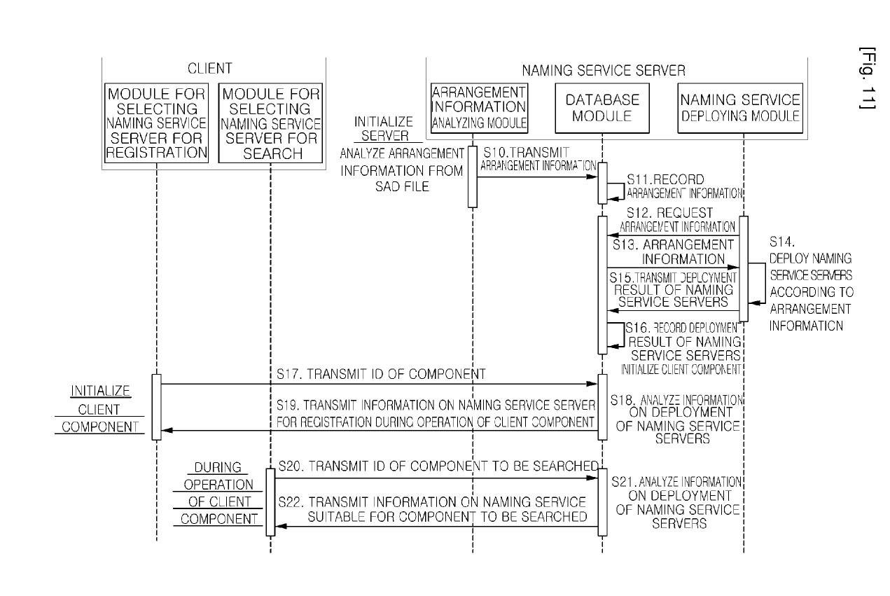

FIG. 10 is a diagram illustrating the structure of a naming service system for an SCA-based application component according to the invention.

The naming service system for an SCA-based application component includes a naming service server 900 and a plurality of clients (client 1, . . . , client n) 910.

The naming service server includes an arrangement information analyzing module 901, a database module 902, and a naming service deploying module 903.

The arrangement information analyzing module 901 analyzes the arrangement information of the components forming an application to be installed from hostcollocation elements of the SAD file, and transmits the arrangement information of the components to the database module 902.

The database module 902 stores the arrangement information of the components transmitted from the arrangement information analyzing module 901 and the deployment result of the naming services by the naming service deploying module 903 in a DB.

The database module 902 receives, from the components forming the application, a request for a naming service server for registering IDs of the components or a request for an optimum naming service server for registering ID of a component to be searched, analyzes the arrangement information of the components stored in the DB and the deployment result of the naming services by the naming service deploying module 903, and transmits to client information on the naming service server information for registering the components or information on the naming service server most suitable for the component to be searched.

The naming service deploying module 903 receives, from the database module 902, the arrangement information of the components analyzed by the arrangement information analyzing module 901, deploys a necessary naming service server on the node, stores the deployment result of the naming services in the database module 902, and keeps information of the components registered in the arranged naming services.

The client includes a module 911 for selecting a naming service server for registration and a module 912 for selecting an optimum naming service server for search.

The module 911 for selecting a naming service server for registration automatically selects a naming service server for registering IDs of components during the start of the components. When the module 911 for selecting a naming service server for registration transmits a query to the database module 902 of the server, the database module 902 of the server analyzes the arrangement information of the components and the deployment result of the naming service servers, and transmits information on a naming service server for registration. Then, module 911 for selecting a naming service server for registration receives information on the naming service server for registration. The module 911 for selecting a naming service server for registration registers the component in the naming service server.

When wanting to search another component during the operation of a component in order for interaction therebetween, the module 912 for selecting an optimum naming service server for search analyzes a naming service request of the component and selects an optimum naming service server. When the module 912 for selecting an optimum naming service server for search transmits a query to the database module 902 of the server, the database module 902 analyzes the arrangement information of the components and the deployment result of the naming service servers, and transmits information on a naming service server used to search the component. The module 912 for selecting an optimum naming service server for search receives information on the naming service server, and queries the naming service server transmitted from the database module 902 for the naming service name of the component.

FIG. 11 is a flowchart illustrating a naming service of an SCA-based application component.

In the naming service of an SCA-based application component, first, a naming service server is initialized, and components forming a client (application) are initialized.

The arrangement information analyzing module 901 analyzes the arrangement information of the components forming an application to be installed from hostcollocation elements of an SAD file, and transmits the arrangement information of the components to the database module 902 (S10).

The database module 902 stores in the DB the arrangement information of the components transmitted from the arrangement information analyzing module 901 (S11), receives a request for transmitting the arrangement information of the components from the naming service deploying module 903 (S12), and transmits the arrangement information of the components to the naming service deploying module 903 (S13).

The naming service deploying module 903 receives, from the database module 902, the arrangement information of the components analyzed by the arrangement information analyzing module 901, deploys necessary naming service servers in the nodes according to information of the naming service allocation table (S14), and transmits the deployment result of the naming services to the database module 902 (S15).

The database module 902 stores the deployment result of the naming services in the DB (S16).

Next, a process of initializing the components forming the client will be described.

The module 911 for selecting a naming service server for registration of the client transmits a request for a naming service server for registering IDs of the components forming the application to the database module 902 of the naming service server 900 (S17).

The database module 902 analyzes information on the deployment of the naming service servers (S18), and transmits information on a naming service server to be registered in the module 911 for selecting a naming service server for registration (S19).

During the operation of the components of the client, the module 912 for selecting an optimum naming service server for search transmits, to the database module 902, a request for a naming service server most suitable for identifying a component to be searched (S20).

The database module 902 analyzes information on the deployment of the naming service servers (S21), and transmits, to the module 911 for selecting a naming service server for registration, information on the naming service server most suitable for the component to be searched (S22).

When requesting to search the IOR of a component, an application selects an optimum naming service from the local naming service and the remote naming service, and receives a high-speed naming service.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A naming service system for an SCA (software communications architecture)-based application component, the system comprising:
an arrangement information analyzing module that analyzes arrangement information of components forming an application from a software assembly descriptor file;
a naming service deploying module that receives the arrangement information of the components and provides the deployment result of naming services on the basis of the received information; and
a database module that stores the arrangement information of the components and the deployment result of the naming services, and transmits the arrangement information of the components and the deployment result of the naming services to a client at the request of the client.

2. The system of claim 1,
wherein the database module receives, from the client, a request for a naming service server for registering IDs of the components forming the application, analyzes the arrangement information of the components and the deployment result of the naming services, and transmits information on the naming service server for registration to the client.

3. The system of claim 1,
wherein the database module receives, from the client, a request for a naming service server most suitable for an ID of a component to be searched, analyzes the arrangement information of the components and the deployment result of the naming services, and transmits, to the client, information on the naming service server most suitable for the component to be searched.

4. The system of claim 1,
wherein the client includes:
a module for selecting a naming service server for registration that, when the component starts its operation, automatically selects a naming service server for registering an ID of the component; and
a module for selecting an optimum naming service server for search that analyzes a naming service request in the component and selects an optimum naming service, when wanting to search the component in order for interaction between the component and another component, during the operation of the component.

5. The system of claim 4,
wherein the client uses a CORBA naming service to search the SCA-based application component.

6. A naming service method of an application component in an SCA-based system, the method comprising:
(a) a step of allowing an arrangement information analyzing module to obtain arrangement information of components forming an application from a software assembly descriptor according to a naming service allocation table, and to store the information in a database module;
(b) a step of allowing a naming service deploying module to deploy local naming service servers according to nodes, on the basis of the arrangement information of the components; and
(c) a step of allowing the database module to receive a request for a naming service server for registering IDs of the components forming the application from a module for selecting a naming service server for registration in a client, to analyze information on the deployment of naming service servers, and to transmit information on a naming service server for registration to the module for selecting a naming service server for registration.

7. The method of claim 6, further comprising:
(d) a step of allowing the database module to, during the operation of the component of the client, receive a request for a naming service server most suitable for an ID of a component to be searched, from a module for selecting an optimum naming service server for search in the client, to analyze the information on the deployment of the naming service servers, and to transmit information on the naming service server most suitable for the component to be searched to the module for selecting an optimum naming service server for search.

8. The method of claim 6, further comprising:
(A) before the step (a), a step of arranging the naming services according to information of the naming service allocation table.

9. The method of claim 8,
wherein the step (A) includes:
(A1) a sub-step of allowing the arrangement information analyzing module to, when there is partitioning information in a SAD file, allocate a new local naming service name to a node corresponding to a portion that designates the components arranged for each node, and to record the newly allocated local naming service name on the naming service allocation table; and
(A2) a sub-step of allowing the arrangement information analyzing module to designate the naming service currently allocated to the node as a local naming service, for the component specified in componentplacement that will be executed in the node.

10. The method of claim 6,
wherein the step (b) includes:
(b1) a sub-step of allowing the naming service deploying module to, when the component uses the naming service, search the naming service allocated thereto from the naming service allocation table;
(b2) a sub-step of allowing the naming service deploying module to determine whether the naming services are allocated thereto from the naming service allocation table, and to register its own IOR (interoperable object reference) in the allocated naming service(s); and
(b3) a sub-step of allowing the naming service deploying module to provide error processing information when the component uses the naming service, but is not allocated with the naming service.

11. The method of claim 6,
wherein the step (b) further includes:
a sub-step of allowing the naming service deploying module to receive the arrangement information of the components from the database module, to deploy necessary naming service servers in the nodes according to information of the naming service allocation table, and to transmit the deployment result of the naming services to the database module.

12. A naming service method of an SCA-based application component, the method comprising:
(a) when a component to be searched uses a naming service, a step of searching the naming services registered in a naming service allocation table;
(b) when one or more naming services are searched, a step of determining whether a local naming service in which the component to be searched is registered is included in the search result of the naming service;
(c) when there is no naming service search result, a step of performing error processing; and
(d) when the local naming service in which the component to be searched is registered is included in the search result of the naming service, a step of using the local naming service to request the search of an IOR of the component to be searched.

13. The method of claim 12, further comprising:
(e) when the local naming service in which the component to be searched is registered is not included in the search result of the naming service, a step of allowing a component that performs a search to use a remote naming service to request the search of the IOR of the component to be searched.

14. The method of claim 13, further comprising:
when the component to be searched is registered in both the local naming service and the remote naming service, a step of allowing the component that performs a search to use the local naming service to request a search.
